(19) United States
(12) Patent Application Publication
(10) Pub. No.: US 2006/0165292 A1
(43) Pub. Date: Jul. 27, 2006

(54) Noise resistant edge detection

(75) Inventor: Xing Li, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 11/043,208

(22) Filed: Jan. 26, 2005

(51) Int. Cl. G06K 9/48

(52) U.S. Cl. 382/199

(57) ABSTRACT

Accurate edge detection requires eliminating pixels that have erroneously been classified as edges prior to image processing. Present systems and methods group recorded background-to-medium and medium-to-background transition points in sets and fit a regression line to each set. Error values are then calculated for the fitted lines, sets with error values that exceed a predetermined amount are excluded and the document edge is identified using the remaining lines. Accordingly, erroneously classified pixels are eliminated quickly enough to keep up with the scanning rate and the edges of a scanned document image can be detected in real-time.

Illustrated herein, generally, are systems and methods for real-time detection of the edges of a scanned document and more particularly, to eliminating pixels that have been erroneously classified as edges prior to performing certain image processing operations.

### BACKGROUND

Digital scanners are commonly used to capture images from hardcopy media. In a typical scanning operation, an original document is placed on a scanning platen and its surface is illuminated while an image sensor moves past the document detecting the intensity of light reflected from each location. Each analog light intensity value is stored as a proportionate electrical charge at a corresponding pixel location and the pixel values are collectively passed to an image processor where they are quantized to grayscale levels. Grayscale levels are represented by multi-bit digital values with a number of bits that has been determined by the number of intensity levels that can be generated by the scanner. For example, a scanner that represents grayscale levels using 8 bit words can generate 256 (2⁸) different levels of intensity. For each location of the image, the multi-bit value for the grayscale level that is the closest match to the measured light intensity is assigned to its corresponding pixel. Thus, scanning captures analog input images by generating a stream of multi-bit values, with each location in the image being represented by a multi-bit digital word.

One or more scanners, printers, video displays and/or computer storage devices are often connected via a communications network to provide a digital reproduction system. For example, a digital copier may incorporate a scanner and a digital printer. While scanners capture hundreds of light intensity levels, digital output devices usually generate relatively few levels of output. For example, digital printers typically process binary output, for which a single bit is assigned to each pixel.

In a system with a digital printer and scanner, the grayscale data generated by the image capture device is usually rendered to binary format and stored in memory. The binary data is retrieved from memory and transmitted to the printer and marking material is either applied to or withheld from the pixel in accordance with the image data. While it is possible to print data as it is rendered, storing it first provides several advantages. For one, when the data is stored, it is possible to print multiple copies of the same page without having to repeatedly re-scan the original document. It is also easier to transfer stored data between devices, as it can be compressed and decompressed.

Many known image processing operations require the identification and use of one or more edges of a scanned document image. For example, skew correction methods typically require identifying at least one edge of the document, calculating the slope of the scanned document image and modifying the coordinates of the captured grayscale pixels to align the scanned image with the original document. Cropping operations often require locating the edges of the scanned document and removing the pixels that lie outside of edges.

Scanners can typically accommodate original documents of various sizes and thus, the area that is scanned is usually larger than the original document. The scanning area is usually covered to prevent external light sources from altering the measured light intensity. Thus, the grayscale data that is generated by a typical scanner typically represents an image of a scanning area with an original document captured inside.

As scanner covers are usually provided in colors that contrast with hardcopy media, pixels that represent the edges of overscanned original documents can be found at the boundary between two regions with distinct grayscale properties. Therefore, the edges of the document image can be identified by comparing the grayscale values of neighboring pixels and recording background-to-medium and medium-to-background “transition points” that are aligned in scanlines and/or columns. Once the edges of the document are located, their slope and spacing can be used to determine the skew angle, shear, size and other registration information about the captured document image and the appropriate correction can be applied so the output will provide an accurate reproduction of the original document.

Dirt, dust particles and other extraneous data is sometimes present on the lenses, mirrors, platen and other parts of the scanner. This extraneous data is often captured with the original document as one or a very small group of pixels. Since the grayscale values of the pixels that represent this extraneous data often differ substantially from those of the neighboring pixels, the image processor sometimes erroneously classifies them as edge pixels.

A known technique for identifying the edges of a document image captured inside a scanning area includes recording several transition points and fitting a regression line to the recorded transition points. However, the presence of extraneous data that has erroneously been classified as edge pixels generates errors during line fitting. Accordingly, it is preferable to correct these erroneous classifications before the edges are used for image processing. Erroneously classified pixels are typically eliminated by performing several line fitting iterations, with some of the erroneously classified pixels identified and eliminated during each iteration.

It takes a great deal of storage space and processing time to perform multiple line fitting operations. One-pass scanners process image data “on-the-fly,” i.e., the grayscale data is generated, processed and rendered in real-time. It would be very difficult to process and store all of the grayscale image data that is generated during all of these iterations quickly enough to keep pace with the scanning rate. Even in a two-pass system in which the full-page grayscale image data is stored before further processing is applied, there is still a need to detect the edged of a document on the fly in order to meet performance requirement.

It is therefore, beneficial to provide an accurate system and method for detecting the edges of a grayscale image in real-time.

### PRIOR ART

US 20030118232 discloses a background detection process that analyzes background information for the purpose of limiting the impact of intensity information obtained from non-document areas, which includes: identifying a first white peak from pixels within a first document region; identifying a second white peak from pixels within a second document region; determining if the first white peak was identified using image data from outside of the input document; and if so, identifying a third white peak from pixels within the first document region based on the second white peak.

U.S. Pat. No. 6,782,129 discloses a method and apparatus are provided for processing image data. A peak count and a valley count are determined within a window which includes a plurality of subwindows. An overall count is determined using the greater of the peak count and the valley count for each subwindow. The image data may then be classified based on this determination.

U.S. Pat. No. 6,744,536 discloses a system and method for determining the registration parameters necessary for registration or edge detection processing to enable the flexibility of changing the color of backing to suit a given application. The method includes scanning the backing surface to obtain at least two sets of gray level values; (b) determining an average gray level for each of the two color channels; (c) selecting a registration channel based on the average gray level; (d) determining a gray level deviation for the registration channel; and (e) determining registration parameters based on the average gray level and the gray level deviation of the registration channel.

U.S. Pat. No. 6,741,741 discloses detecting document edges by scanning a portion of the document against a substantially light reflecting backing and then against a substantially light absorbing backing document edges are detected by comparing the data from the two scans.

U.S. Pat. No. 6,674,899 discloses a method for generating a background statistics that distinguishes between gray level information from document areas and non-document areas that includes determining full page background statistics from selected pixels within a scanned area; determining a sub-region background statistics from selected pixels within a sub-region of the scanned area; determining if the sub-region background statistics corresponds to image data from a non-document area; determining if the full page background statistics is corrupted; and generating a validated full page background statistics if the full page background statistics is corrupted.

U.S. Pat. No. 6,621,599 discloses providing automatic detection of the width and position of a document which is substantially insensitive to dust and dirt as well as electrical noise with an image capture device. When a document is staged for image capture, the image capture device collects several scanlines of the backing without the document and several scanlines of the lead edge of the document with the backing. The backing image collected is then subtracted from the lead edge image collected, and the resulting image is readjusted. Accordingly, variations in the backing areas of the lead edge image are removed and edge detection failure or error are reduced or eliminated.

U.S. Pat. No. 6,198,845 discloses determining the background grey-level of a document based on the gain of the document. A histogram is generated and compressed. The standard deviation of the distribution curve of the compressed histogram is determined. A gain factor is determined using the mean and standard deviation. Using the background grey-level, the dynamic range of the document is adjusted.

U.S. Pat. No. 5,166,810, discloses an image quality control system for an image processing system for producing an image of high quality by removing noise and mesh-dot components from image input signals representing a scanned original image comprising (1) a low-pass smoothing filter adapted for removing from image input signals representing a halftone image substantially all of any mesh-dot component, for smoothing the image input signals representing the halftone image, and for producing smoothed output signals representing the smoothed image input signals, (2) a smoothing modulation table for modulating the smoothed output signals of the smoothing filter to produce modulated smoothed output signals, (3) a bandpass edge detect filter for detecting edge component signals of the image input signals, the edge component signals comprising a high frequency component of the image input signals, the edge detect filter producing edge output signals, (4) an edge emphasis modulation table for modulating the edge output signals to produce modulated edge output signals, and (5) means for selecting parameters of the bandpass edge detect filter, the low-pass smoothing filter, the smoothing modulation table, and the edge emphasis modulation table for every image signal such that the modulated edge output signals and the modulated smoothed output signals correspond to the image input signals with the noise and mesh-dot components thereof substantially removed.

### SUMMARY OF THE INVENTION

In one aspect, a system includes an image processor configured to interval sample a grayscale image in a first component direction, wherein the grayscale image represents a document image captured inside a scan image; record transition points that are detected at each sampling interval; group the transition points into a plurality of transition point sets; derive a regression line for each of the plurality of transition point sets; determine a regression fit error for at least one of the regression lines; and identify an edge of the document image based upon a characteristic of at least one of the set regression lines.

In another aspect, a method includes interval sampling a grayscale image that represents a document image captured inside a scan image; recording transition points that are detected at each sampling interval; grouping the transition points into a plurality of transition point sets; deriving a regression line for each of the plurality of transition point sets; determining a regression fit error for at least one of the regression lines; and identifying an edge of the document image based upon a characteristic of at least one of the set regression lines.

### BRIEF DESCRIPTION OF THE DRAWINGS

FIG. 1 provides one example of a system for digitally reproducing hardcopy images.

FIG. 2 is an example of an original document that has been transported to a scanning area for image capture;

FIG. 3 provides an example of how transition points may be arranged in groups for line fitting; and

FIG. 4 illustrates the difference in the error magnitude values for transition points that have been properly classified as edge pixels and pixels that have been erroneously classified as edge pixels.

### DETAILED DESCRIPTION

For a general understanding of the present system and method, reference is made to the drawings. In the drawings, like reference numerals have been used throughout to designate identical elements. In describing the present system and method, the following term(s) have been used in the description:

A “raster input scanner,” also referred to as a “RIS” or a “scanner” is a device that captures images from a hardcopy medium and converts them to digital format. The term “scanner” includes any such device, whether flat-bed, hand-held, feed-in, and includes devices that capture images in color or only in black-and-white.

The “fast-scan direction” refers to the direction followed by the scanner as it moves past the original document to capture the input image. The “slow scan direction” lies normal to the fast-scan direction and is typically the direction in which documents are transported to the scanning surface.

A “pixel” refers to an image signal having a density between white (i.e., 0) and black (i.e., the maximum available intensity value) that is associated with a particular position in an image. Accordingly, pixels are defined by intensity and position. The term “pixel” refers to such an image signal in a single separation. A “color pixel” is the sum of the color densities of corresponding pixels in each separation.

A “scanline” is the set of pixels that represents the data captured in a single sweep of the image in the fast-scan direction.

“Scan area” and “scanning surface” refer to the entire location that is captured by the scanner, which typically includes the document bearing the image and the scanner background.

“Data” refers to physical signals that indicate or include information and includes information that exists in any physical form. For example, data could exist as electromagnetic or other transmitted signals, it could exist as signals that are stored in electronic, magnetic, or other form, and it may be information that is transitory or is in the process of being stored or transmitted. Data is typically processed by a set of instructions, such as a software program or application, to generate output.

Data that is processed in “real-time” is processed as it is received.

“Gray level” refers to one among several available increments of image intensity that vary between a minimum value and a maximum, regardless of the color of the separation in which one or more of the levels may be found. The term “gray” does not refer to a color unless specifically identified as such.

A “grayscale value” is a numerical value that indicates the optical density of an image at a given pixel.

A “document” includes any medium that is capable of bearing a visible image. An “original document” is a document that bears the image that is being or has been presented for digital capture.

An “image” is generally a pattern of physical light that may include characters, words, and text as well as other features such as graphics. An entire image is typically represented by a plurality of pixels arranged in scanlines.

“Image data” refers to information that represents an image. “Original image data” is image data that is delivered to a system or device by an external source. “Grayscale image data” refers to image data that represents and black and white and/or color images that have multiple luminance levels, with each pixel defined at a single optical density.

“Memory” is any circuitry that can store data, and may include local and remote memory and input/output devices. Examples include semiconductor ROMs, RAMs, and storage medium access devices with data storage media that they can access.

An “edge” refers to the boundary of the original document. The “lead edge” of a document is the edge of the document that is first captured by the image sensor.

A “transition point” is a pixel in a grayscale image with a grayscale value that differs substantially from that of the previously processed pixel. A “background-to-medium transition point” is one of the first processed pixels with a grayscale value that represents the original document after pixels with grayscale values that represent the background pixels have been processed. A medium-to-background transition point is one of the first background pixels that are processed after several original document pixels that are processed.

A “transition point” is a grayscale image pixel that lies at the boundary of two regions with distinct grayscale properties. A “background-to-medium transition point” is a first pixel with a grayscale value that represents the original document that is detected after several pixels that represent the scanner backing have been detected. A “medium-to-background transition point” is a first pixel with a grayscale value that represents the scanner backing that is detected after several pixels that represent the original document have been detected.

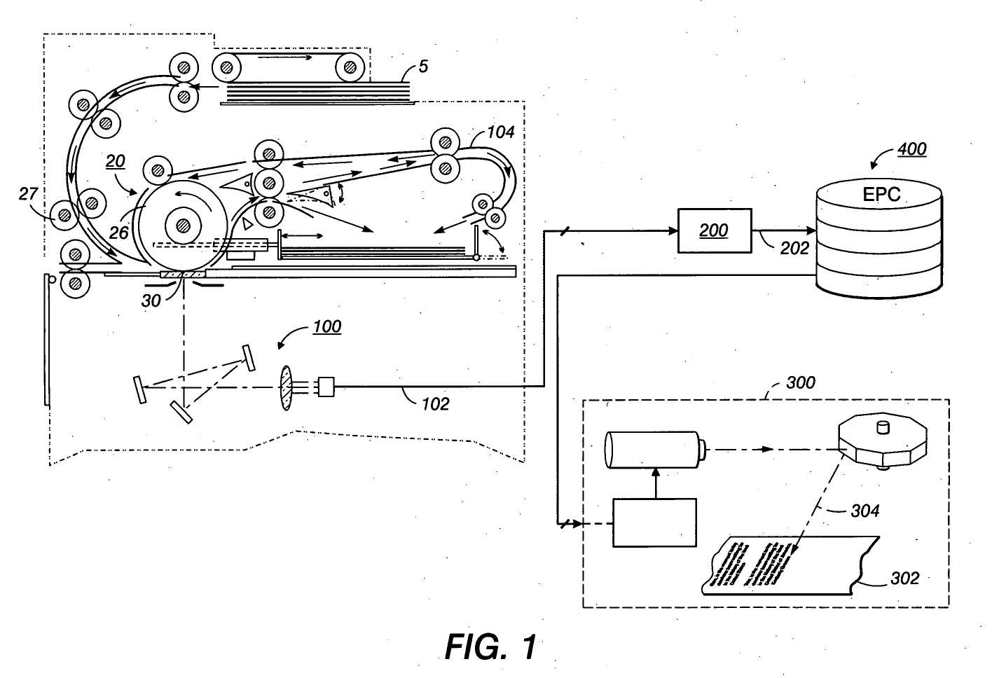

Generally, digital reproduction systems include an image source, which provides grayscale data that represents an original image; an image processor, which performs various image modifications and stores the processed data in an electronic pre-collation memory; and an output device, which retrieves the output formatted data and displays it in a viewable format. An example of such a digital reproduction system 10 is illustrated in FIG. 1. In system 10 of FIG. 1, the image source is a raster input scanner (RIS) 100 and the output device is a xerographic digital printer 300. System 10 scans original documents 5 line-by-line, detecting the intensity of light reflected from each discrete location and storing it as a proportionate electrical charge in a corresponding pixel location. Printed reproductions are then provided by generating generate grayscale image data 102 that represents the intensity of light reflected from the image, which is rendered to binary format to provide hardcopy reproductions.

Original documents 5 are transported to a scanning surface 30 in the direction of axis Y, often via an automated document feeder or constant velocity transport (“CVT”) system 104. Generally speaking, CVT 104 includes a backing roll 20 rotatably mounted above the scanning area of RIS 100, where original documents 5 are received from one or more transport rollers 2 and 27 for transport across scanning area 30. While the goal is usually to scan only the original document, RIS 100 generates image data that represents everything in scanning area 30, e.g., backing roll 20 and other scanner hardware. Thus, the grayscale image data generated by RIS 100 includes an original document image 18 captured inside a scan image 34. Image processor (IP) 200 then converts grayscale image data 102 to binary data 202 or some other format that is suitable for output and stores it in EPC 400.

To produce hardcopy reproductions, binary image data 202 is retrieved from EPC 400 as a continuous stream of electronic signals and used to modulate a light beam 204 that selectively discharges the surface of a uniformly charged imaging member 302. Toner material 306 is brought in contact with imaging member 302, adhering to the charged areas of the imaging member and the toner developed image is then transferred and permanently fixed to a copy sheet, thereby transforming the binary data retrieved from EPC 400 to markings that are printed on the output copy sheet. While system 10 is described as having binary image data 202 that is retrieved by from EPC by printer 300, it is understood that it is possible to reproduce images by transmitting binary image data 202 directly to printer 300, by making binary image data 202 available via a removable storage device or by any other appropriate delivery method.

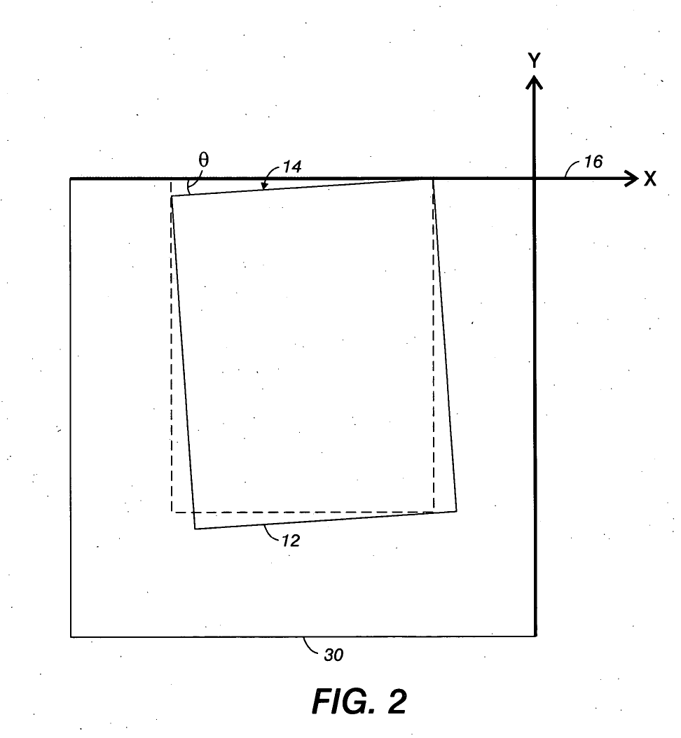

As shown in FIG. 2, a scanning area 30 of a RIS 100 typically has a slow scan direction Y, which corresponds to document transport direction, and a fast scan direction X normal to direction Y. Generally, the lead edge 14 and trail edge 12 of the document can be identified by locating transition points in the slow-scan direction. To locate slow-scan direction transition points, the grayscale values for pixels in an earlier captured scanlines are compared to those of the corresponding pixels in subsequently captured scanlines and a transition point is recorded at the first pixel with a gray value that differs from that of the corresponding pixel from the previously captured scanline by more than a threshold. Similarly, left edge 22 and right edge 24 of document image 18 can be identified by locating transition points in the fast-scan direction, which are identified based upon a relative comparison of the grayscale values for pixels in the same scanline.

In one aspect, transition points are recorded by sampling scan image 30 in the fast-scan and/or slow-scan directions, rather than by processing every pixel in the image. For example, pixels that represent lead edge 14 and trail edge 12 of document image 18 can be identified as the scanner moves in the fast-scan direction across scanning area sampling grayscale image data 102 at “x” pixel intervals and measuring the relative grayscale value for pixels that are aligned in slow-scan direction Y (i.e., in columns). In another aspect, the left edge 22 and right edge 24 of document image 18 can be identified as the scanner moves in the slow-scan direction taking samples at “y” pixel intervals and measuring the relative grayscale value for pixels that are aligned in fast-scan direction X (i.e., in rows). In one aspect, y and/or y are programmable values. It is noted that systems and methods may be arranged such that x=y, x>y or x<y.

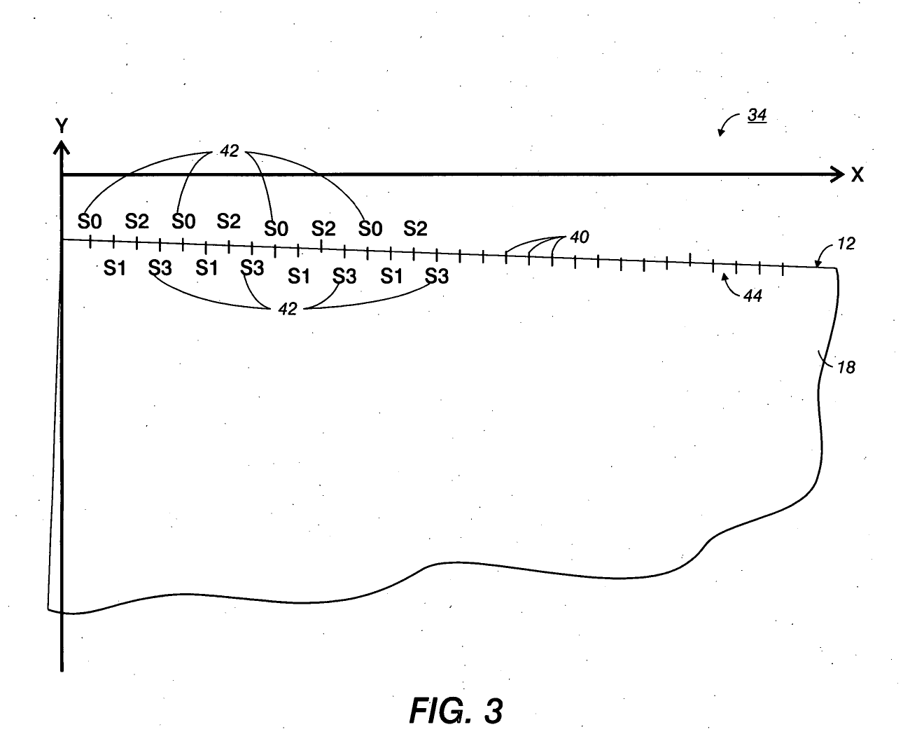

Turning to FIG. 3, present systems and methods process scan image 34 in real-time by identifying transition points 40 in document image 18. For each edge, i.e., lead edge 14, trail edge 12, left edge 22, right edge 24, the identified transition points 40 are grouped into sets 42. A line 44 is then fitted to each set 42 and final determinations of the edges are made based upon the relative positioning of lines 44 that have been fitted to the multiple sets 42 of transition points 40.

In one example, the image is sampled until a predetermined number of transition points 40 have been recorded and detected transition points 40 are grouped into a predetermined number of sets 42 pixels. For example, transition points 40 for lead edge 14 and trail edge 12 may be identified by sampling scan image 34 every 32 scanlines and grouping transition points in four sets, each of which includes eight pixels. However, samples could easily be recorded in fewer or more that four sets and/or in groups that include fewer or more than 8 pixels. In one aspect, the sampling interval is 2ⁿ pixels, where n is a positive integer value. In another aspect, the sampling interval is X/m pixels, where X is a maximum number of pixels in the scanline (or column) and X is evenly divisible by m.

In one aspect, transition points may be distributed among the sets in the order in which they are captured. For example, the first identified transition point could be placed in set s0, the second identified transition point could be placed in set s1, the third identified transition point could be placed in set s2, etc. It is understood, however, that transition points could be distributed among the sets based upon their position within the captured scan, or in numerous other ways and thus, present systems are not limited to having transition points distributed in a specific manner.

As shown in FIG. 3, IP 200 may search for lead edge 14 and generate groups 42 of transition points 40 by distributing consecutively recorded samples. For example, in one aspect, the first sample is assigned to a set s0, the second sample is assigned to a set s1, the third sample is assigned to a set s2 and the fourth sample is assigned to a set s3. Subsequently recorded samples are distributed in the same way. That is, the fifth sample is assigned to set s0, the sixth sample is assigned to set s1, and so on, until all of the samples have been distributed.

Present systems and methods include fitting multiple regression lines to different subsets of the transition points that are recorded and calculating an error value for each regression line. The transition points that have been matched to lines with error values that exceed a predetermined amount are then excluded and the edge is identified using the matching lines that have been fitted to the remaining transition points.

In one aspect, the error values that are calculated for each set are based upon at least one of the following values:

X=the accumulated sum of the x coordinates of the pixels in the set;

XX=the accumulated sum of the squares of the x coordinates of the pixels in the set;

Y=the accumulated sum of the y coordinates of the pixels in the set;

YY=the accumulated sum of the squares of the y coordinates of the pixels in the set;

XY=the accumulated sum of the product of the x and y coordinates of the pixels in the set;

PixelNumber=the number of pixels that have been recorded in the set.

These values can be used to determine the slope, location and regression fit error for each of the regression lines. In one aspect, the regression fit error may be determined by calculating the sum of a square of a distance between each transition pixel in the set and its respective regression line. Generally, the error for regression lines that identify lead edge 14 and trail edge 12 will depend upon Y and YY, while the error for regression lines that identify left edge 22 and right edge 24 will depend upon X and XX. XY may be useful in comparing the slopes of multiple regression lines. In one aspect, the difference in the slopes of multiple regression lines may also be used to identify one or more edges of document image 18.

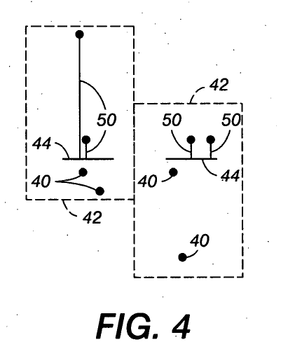

Turning to FIG. 4, when a transition point set includes extraneous data 52, the regression fit error will be relatively large compared to that of the transition point sets that only include transition points that do in fact represent the edge of the original. Thus, transition point sets that include extraneous data 52 can be eliminated based upon a comparison of their regression fit error to a maximum error value and edge detection can be performed based upon the most accurate data from the scan.

In one aspect, a maximum error value may be determined by the characteristics of the scanner as well as the expected alignment for the edges of the document. For example, many digital reproduction systems require an original document to be re-scanned when the detected skew exceeds a predetermined amount. In one aspect, the maximum error value could be set where the skew in the regression line would exceed this predetermined amount. The maximum error value could also be set based upon past history of the system, user input and in many other ways. Accordingly, present systems and methods can be used to accurately measure the skew and dimensions of a scanned document image, the location of the document image inside the captured scan and other desired values.

The principles of the present system and method are generally applicable to any application that uses the slope of one or more document edges or the skew angle of a document. Furthermore, it should be understood that the principles of the present system and method are applicable to a very wide range of apparatus, for example, copiers, facsimile machine, printers, scanners, and multifunction devices and that they are useful in machines that reproduce black and white and color images by depositing ink, toner and similar marking materials.

Although the present system and method has been described with reference to specific embodiments, it is not intended to be limited thereto. Rather, those having ordinary skill in the art will recognize that variations and modifications, including equivalents, substantial equivalents, similar equivalents, and the like may be made therein which are within the spirit of the invention and within the scope of the claims.

What is claimed is:

1. A method, comprising:
interval sampling a grayscale image that represents a document image captured inside a scan image;
recording transition points that are detected at each sampling interval;
grouping said transition points into a plurality of transition point sets;
deriving a regression line for each of said plurality of transition point sets;
determining a regression fit error for at least one of said regression lines; and
identifying an edge of said document image based upon a characteristic of at least one of said set regression lines.

2. A method as claimed in claim 1 wherein said regression line characteristic is a difference in slope among a plurality of said regression lines.

3. A method as claimed in claim 1 wherein said regression line characteristic is a regression fit error.

4. A method as claimed in claim 3 further comprising identifying said document image edge based upon whether said regression fit error exceeds a maximum error value.

5. A method as claimed in claim 3 wherein said regression fit error is determined based upon difference between a sum of a square of a distance between said transition points in said transition point set a respective regression line.

6. A method as claimed in claim 3 wherein said regression fit error is dependent upon a fast-scan direction component of said transition points in said transition point set.

7. A method as claimed in claim 3 wherein said regression fit error is dependent upon a slow-scan direction component of said transition points in said transition point set.

8. A method as claimed in claim 1 further comprising determining a slope of said document image edge.

9. A method as claimed in claim 1 further comprising identifying a plurality of said document image edges and determining a location of said document image within said scan image based upon a location of said plurality of document image edges.

10. A method as claimed in claim 1 further comprising interval sampling said grayscale image in a slow-scan direction.

11. A method as claimed in claim 10 wherein said grayscale image slow-scan direction sampling interval is 2ⁿ scanlines, where n is a positive integer value.

12. A method as claimed in claim 10 wherein said grayscale image slow-scan direction sampling interval is Y/n scanlines, where Y is a maximum number of scanlines in said grayscale image and Y is evenly divisible by n.

13. A method as claimed in claim 1 further comprising interval sampling said grayscale image in a fast-scan direction.

14. A method as claimed in claim 13 wherein said grayscale image fast-scan direction sampling interval is 2^{m} pixels, where m is a positive integer value.

15. A method as claimed in claim 13 wherein said grayscale image fast-scan direction sampling interval is X/m pixels, where X is a maximum number of pixels in each scanline and X is evenly divisible by m.

16. A system that includes an image processor, said image processor being configured to:
interval sample a grayscale image that represents a document image captured inside a scan image;
record transition points that are detected at each sampling interval;
group said transition points into a plurality of transition point sets;
derive a regression line for each of said plurality of transition point sets;
determine a regression fit error for at least one of said regression lines; and
identify an edge of said document image based upon a characteristic of at least one of said set regression lines.

17. A method as claimed in claim 16 wherein said regression line characteristic is a difference in slope among a plurality of said regression lines.

18. A method as claimed in claim 16 wherein said regression line characteristic is a regression fit error.

19. A system as claimed in claim 16 further comprising:
a document transport configured to move an original document in a slow scan-direction to a scanning surface; and
an image sensor configured to move across said original document in a fast scan direction to detect the intensity of light reflected from said scanning surface and convert said reflected light into a grayscale representation of an original document image inside a scan image.

20. A system as claimed in claim 16 further comprising a digital printer configured to:
receive said output device formatted data as a continuous stream of binary signals; and
process said binary signals to transform said binary data to markings that are printed on an output copy sheet.
